(19) United States
(12) Patent Application Publication
(10) Pub. No.: US 2011/0196563 A1
(43) Pub. Date: Aug. 11, 2011

(54) AUTONOMOUS NAVIGATION AND INK RECOGNITION SYSTEM

(75) Inventors: Mark Yturralde, San Diego, CA (US); Graham Ross, Poway, CA (US)

(73) Assignee: CAREFUSION 303, INC., San Diego, CA (US)

(21) Appl. No.: 12/703,159

(22) Filed: Feb. 9, 2010

(51) Int. Cl. G05D 1/00

(52) U.S. Cl. 701/25; 701/28

(57) ABSTRACT

A mobile robot is disclosed. The mobile robot includes a housing. The mobile robot includes a memory module coupled to the housing. The memory module is configured to store an image file of at least one ink mark that is arbitrarily shaped and is human-imperceptible and that forms a landmark on a navigable route. The mobile robot includes a detector mounted to the housing. The detector is configured to detect ink marks marked on a surface. The mobile robot includes a confidence matching system coupled to the memory module and the detector. The confidence matching system is configured to determine whether a detected ink mark is a landmark based on a comparison of the detected ink mark with the stored image file of the at least one ink mark. The mobile robot includes a navigation system coupled to the confidence matching system configured to navigate the robot through an area including the navigable route based on recognition of the landmark.

### BACKGROUND

1. Field

The present disclosure generally relates to systems and methods of autonomous navigation, and, in particular, relates to autonomous navigation employing ink pattern recognition.

2. Description of the Related Art

Some robots have been used as substitutes to autonomously perform activities typically performed by humans. Some activities may be considered dangerous for humans to perform and robots can be used as an expendable asset. Other activities may be considered routine and thus, robots permit human resources to be utilized for other matters. Certain activities can be done by robots cost-effectively by pre-programming a mobile robot to travel through areas and perform the desired activity.

For example, one activity that robots may perform is the autonomous delivery of supplies between stations. Hospitals in particular may use many consumable items and can benefit from robots delivering supplies to different stations to replenish resources. In this exemplary application, a mobile robot can be configured to maneuver down, for example, hospital corridors until it reaches a programmed destination. However, obstacles may confront a mobile robot thus, causing the robot to be stalled or causing the robot to deviate from it programmed course of travel.

Some robots may navigate through an area autonomously by employing systems using dead reckoning. Dead reckoning may employ tracking direction and distance traveled from a known starting point. Robots employing dead reckoning may be subject to position error built up along their course of travel over long distances, such as down long hospital corridors.

Other robots may use reflective markers or identifiable markers affixed in an area at predetermined intervals for a robot to search for and acknowledge. Some reflective markers or identifiable markers may be subject to interference from objects obstructing their view from the robot. For example, hospital corridors and rooms may contain numerous mobile objects such as furniture, gurneys, and supply carts that may be temporarily placed in front of markers. In other instances, the markers may be unintentionally removed. In either of these two instances, a robot searching for reflective markers or identifiable markers that are obstructed or missing may encounter an error in navigation and may otherwise become lost.

Another approach may use global positioning systems (GPS) coupled to a robot where the robot references a GPS map while traveling. A GPS approach may be subject to interference, for example, from other electrical equipment present in hospital environments.

Another approach to autonomous navigation may rely on the use of visible light landmarks that may be easily occluded. Since people may be able to see the landmarks, some people may remove the landmarks or may interfere with the landmarks being detected.

Other applications for autonomous navigation may employ invisible landmarks, such as bar codes built into a flooring. High traffic areas such as hospital corridors and rooms may produce staining, damage or covering of the flooring and may interfere with reading of the bar codes.

### SUMMARY

Embodiments of the mobile robot and autonomous navigation system disclosed herein assist a mobile robot in navigating through an area by recognition of ink patterns. In certain embodiments, the recognition system matches a detected ink pattern to a stored ink pattern.

In certain embodiments of the disclosure, a mobile robot is disclosed. The mobile robot includes a housing. The mobile robot includes a memory module coupled to the housing. The memory module is configured to store an image file of at least one ink mark that is arbitrarily shaped and is human-imperceptible and that forms a landmark on a navigable route. The mobile robot includes a detector mounted to the housing. The detector is configured to detect human-imperceptible ink marks marked on a surface. The mobile robot includes a confidence matching system coupled to the memory module and the detector. The confidence matching system is configured to determine whether a detected ink mark is a landmark based on a comparison of the detected ink mark with the stored image file of the at least one ink mark. The mobile robot includes a navigation system coupled to the confidence matching system configured to navigate the robot through an area including the navigable route based on recognition of the landmark.

In certain embodiments of the disclosure, a method of navigating a robot is disclosed. The method includes recording a random pattern of invisible marks in an area as a map file in the robot. The method includes detecting the invisible marks using a camera mounted to the robot and wherein the camera is configured for detecting light in the non-visible spectrum. The method also includes navigating the robot through the area based on the robot recognizing the detected invisible marks.

In certain embodiments of the disclosure, a system of autonomous robot navigation is disclosed. The system includes a mobile robot. The system includes a detector coupled to the mobile robot, the detector configured to detect non-uniform invisible ink marks disposed on vertical surfaces. The system also includes a processor coupled to the mobile robot. The processor is configured to match the detected non-uniform invisible ink marks to pre-stored image files of landmarks based on a minimum number of shape features detected in the detected non-uniform invisible ink marks. The processor is further configured to determine whether detected non-uniform invisible ink marks match a stored map file of predetermined locations of non-uniform invisible ink marks.

In certain embodiments of the disclosure, a mobile robot navigation system is disclosed. The robot navigation system includes a memory module including stored image files of landmarks and stored maps of navigable areas including landmarks. The robot navigation system includes a confidence matching module coupled to the memory module. The confidence matching module includes an image constructor configured to reconstruct virtual images from data representing detected arbitrarily-shaped and human-imperceptible ink marks. The robot navigation system also includes a processor coupled to the memory module and the confidence matching module. The processor is configured to compare the reconstructed virtual images to one or more of the stored image files. The processor is also configured to determine whether one of the detected arbitrarily-shaped and human-imperceptible ink marks is one of the landmarks based on the comparison. The processor is also configured to generate a command signal to navigate a mobile robot through one of the navigable areas based on a location of the detected landmark in one of the stored maps.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a block diagram illustrating an example of a hardware configuration for an autonomous navigation system according to certain embodiments.

FIG. 1A is a block diagram illustrating an example of a detector module of FIG. 1.

FIG. 1B is a block diagram illustrating an example of a memory module of FIG. 1.

FIG. 1C is a block diagram illustrating an example of a confidence matching module of FIG. 1.

FIG. 2 is a diagram illustrating an example of a mobile robot of FIG. 1.

FIG. 3 is a diagram illustrating an example of a random pattern of arbitrarily-shaped ink marks on a surface according to certain embodiments.

FIG. 4 is a diagram illustrating a mobile robot according to certain embodiments.

FIG. 5 is a flow chart illustrating an exemplary process of autonomous navigation employing the system of FIG. 1.

FIG. 6 is a diagram illustrating an example of an area for autonomous navigation of a mobile robot according to certain embodiments.

FIG. 6A is a diagram illustrating an example of recognizing features of an arbitrarily-shaped ink mark.

FIG. 7 is a flow chart illustrating an exemplary process of matching detected ink marks to stored ink marks of FIG. 5.

FIG. 8 is a block diagram illustrating an example of the functionality of a processing system in a mobile robot of FIG. 1.

### DETAILED DESCRIPTION

Systems employing landmarks for use in autonomous navigation can be disrupted by obscuration of, or damage incurred, on the landmarks. Landmarks may be unintentionally covered by temporarily placed objects, such as furniture. Landmarks may also be partially damaged by, for example, dents or abrasions on a surface, or by wear and tear, such as what happens to landmarks placed on floor surfaces. Landmarks that are perceptible under visible light wavelengths may invite vandalism to their presence or may detract from the aesthetics of a surface. These and other problems are addressed and solved, at least in part, by embodiments of the present disclosure. Certain exemplary embodiments of the present disclosure include a system that identifies invisible landmarks. In certain exemplary embodiments, the landmarks are positioned on a vertical surface. The landmarks are arbitrarily-shaped in exemplary embodiments. The system may compare the identified landmarks to stored landmarks. In certain exemplary embodiments, the system performs a confidence matching process to identify landmarks that may be obstructed or damaged.

In the following detailed description, numerous specific details are set forth to provide a full understanding of the present disclosure. It will be obvious, however, to one ordinarily skilled in the art that embodiments of the present disclosure may be practiced without some of the specific details. In other instances, well-known structures and techniques have not been shown in detail so as not to obscure the disclosure.

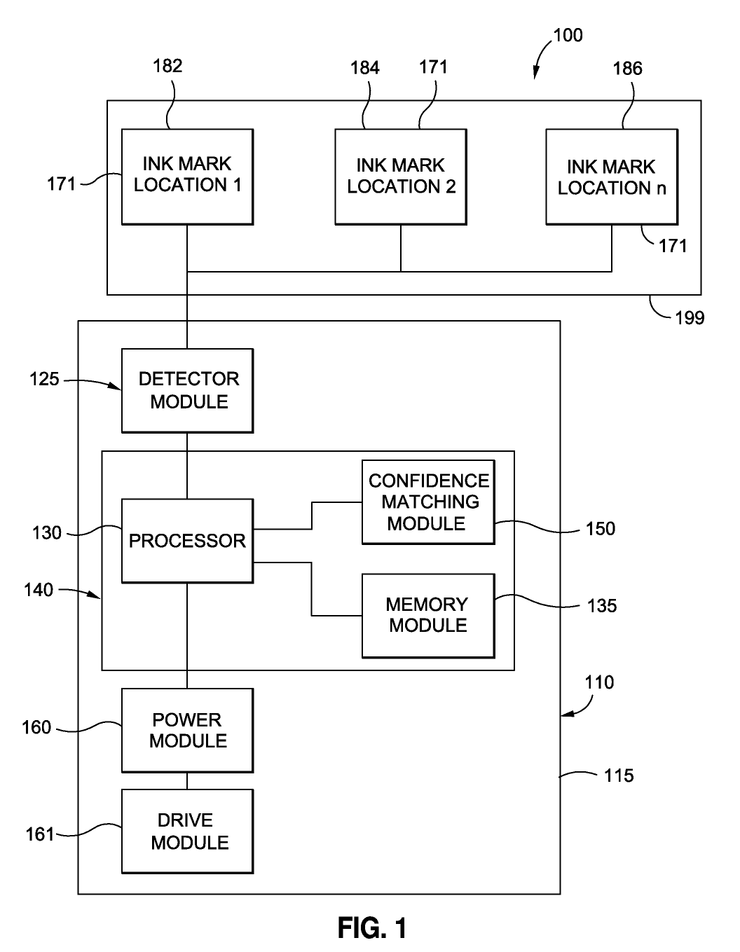

Referring concurrently to FIGS. 1, 1A, 1B, and 1C, a system 100 is illustrated according to a block diagram. The system 100 includes a mobile robot 110 that interacts with one or more landmarks 171. For sake of illustration throughout, while a landmark may be referred to as a landmark 171, it will be understood that each landmark 171 may be a physically different location within an area 199 and that each respective landmark 171 may comprise individual information distinguishable from every other landmark 171. For example, a first landmark 171 is distinguishable from every other landmark 171, and likewise, a second landmark 171 is distinguishable from every other landmark 171, and so on. However, in other embodiments, the landmarks 171 are not distinguishable from each other. The landmarks 171 may be positioned at various locations in a navigable area 199. In one example, a plurality of landmarks 171 may be positioned at first landmark location 182, a second landmark location 184, and up through and including an indefinite nth landmark location 186.

The mobile robot 110 includes a housing 115, a detector module 125, a navigation system 140, a drive module 161, and a power module 160 coupled to one another. The navigation system 140 includes a processor 130, a memory module 135 and a confidence matching module 150. The drive module 161 includes the mechanics for movement of the mobile robot 110. What is not illustrated in FIGS. 1 and 1A-1C are the mechanics for moving the mobile robot 110, when guided by the navigation system 140. Such mechanics for moving a robot according to a navigation system's commands are well-known.

The detector module 125 is configured to detect landmarks 171 located in the area 199. Referring especially now to FIG. 1A, the detector 125 in certain exemplary embodiments, includes a camera 123 and a light source 127. According to certain exemplary embodiments, the camera 123 is configured to detect light in the non-visible spectrum. For example, the camera 123 is configured to detect landmarks visible in the ultra-violet (UV) or infra-red (IR) wavelength spectrums. The light source 127 is configured in such embodiments, to illuminate landmarks 171 disposed on a surface. In certain aspects, the light source 127 is configured to emit light in invisible wavelengths. For example, the light source 127 may emit light in the ultraviolet spectrum. In other embodiments, the light source 127 emits light in the infra-red spectrum. In still other embodiments, the light source 127 emits light in the visible light spectrum. All of these types of light sources 127 are well known. Cameras 123 for detecting light in the non-visible spectrum, are also well-known. The detector module 125 includes a range finder 129 configured to detect a distance between the mobile robot 110 and a detected landmark, in certain embodiments. Such a range finder can be an ultrasonic range finder as one example.

The navigation system 140 is configured to cause the mobile robot 110 to move in one or more directions according to detection of landmarks 171. The navigation system 140, in certain embodiments, is a modular unit that can be mounted as an added component into existing robots. The navigation system 140 navigates the mobile robot 110 along navigable routes through an area 199 according to command signals generated by the processor 130. The command signals are generated by the processor 130 based on recognition of a landmark 171 and information associated with the landmark 171.

The processor 130 is configured to process data received from the detector module 125. The processor 130 processes data to and from the confidence matching module 150. The processor 130 processes data to and from the memory module 135. In certain aspects, the processor 130 is configured to process data as an intermediary between one or more of the detector module 125 module, the memory module 135, and the confidence module 150. The processor 130 processes data based on the detection of landmarks 171 to coordinate a direction of travel for the mobile robot 110.

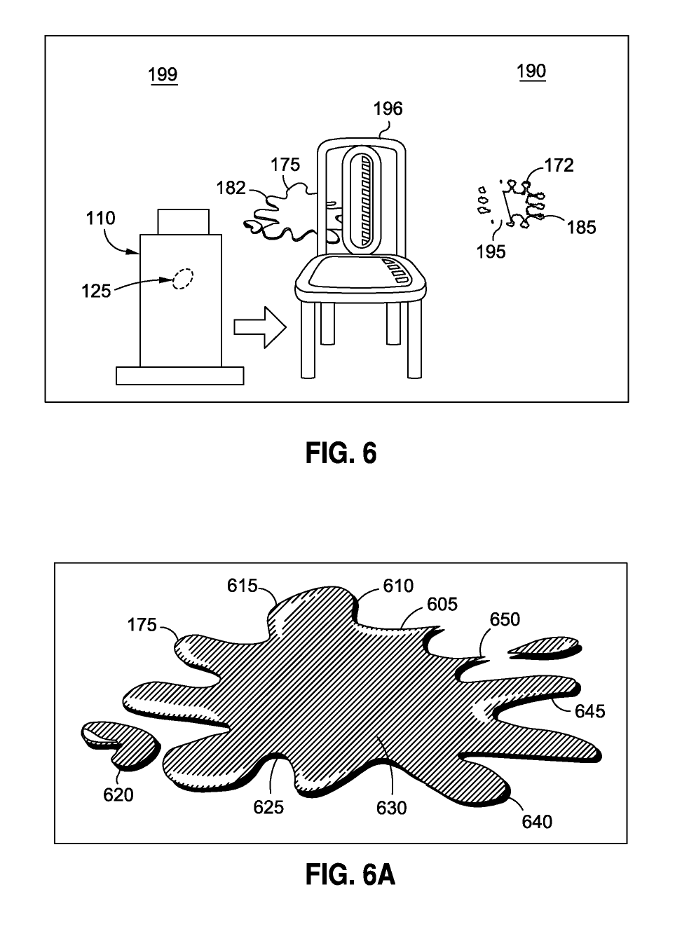

The memory module 135 (see especially FIG. 1B) is configured to store files employed during an autonomous navigation of the mobile robot 110 through the area 199. For example, the memory module 135 may be configured to store a map file 136 associated with areas traversed by the mobile robot 110. The memory module 135 may include an areas file 137 of data representing different areas of navigation. The map file 136 may also be configured to store a file associated with navigable routes in a routes file 139. According to certain aspects, the map file 136 may include a locations file 138 of landmarks 171. The memory module 135 is configured to store image files 131 representing landmarks 171 in the map 136. The landmarks 171 are represented by their respective shape as disposed on a surface. The image files 131 include images representing the shape of a landmark 171 associated with one or more locations 182, 184 through 186 (see especially FIG. 1), in the map 136. In certain exemplary embodiments, the image files 131 are generated by electronically pre-capturing images of the landmarks 171 disposed on a surface in a navigable area, such as an area 199. The memory module 135 is configured to store a file of patterns 133 associated with for example, an arrangement of pre-captured images of multiple landmarks 171 at locations 182, 184 through 186 (see especially FIG. 1), in certain embodiments. In another aspect, the memory module 135 is configured to store files of features 132 associated with stored image files 131. Features associated with a landmark 171 may be used for confidence matching and will be discussed in further detail with reference to FIG. 6A below.

The confidence matching module 150, (see FIG. 1C) is configured to compare detected landmarks 171 with stored image files 131. The confidence matching module 150 in FIG. 1C includes a feature comparator 152, an image constructor 154, and a stored threshold value 156. The feature comparator 152 is configured to extract features from detected landmarks 171 and compare the extracted features to the stored files of features 132 in the memory module 135. The image constructor 154 is configured to reconstruct a virtual image of a detected landmark 171 from data received from the detector module 125.

The power module 160 is configured to provide power to the navigation system 140, the processor 130, the detector module 125, the confidence matching module 150, the drive module 161, and the memory module 135. It will be understood that the power module 160 also provides power to other elements (not shown) of the mobile robot 110.

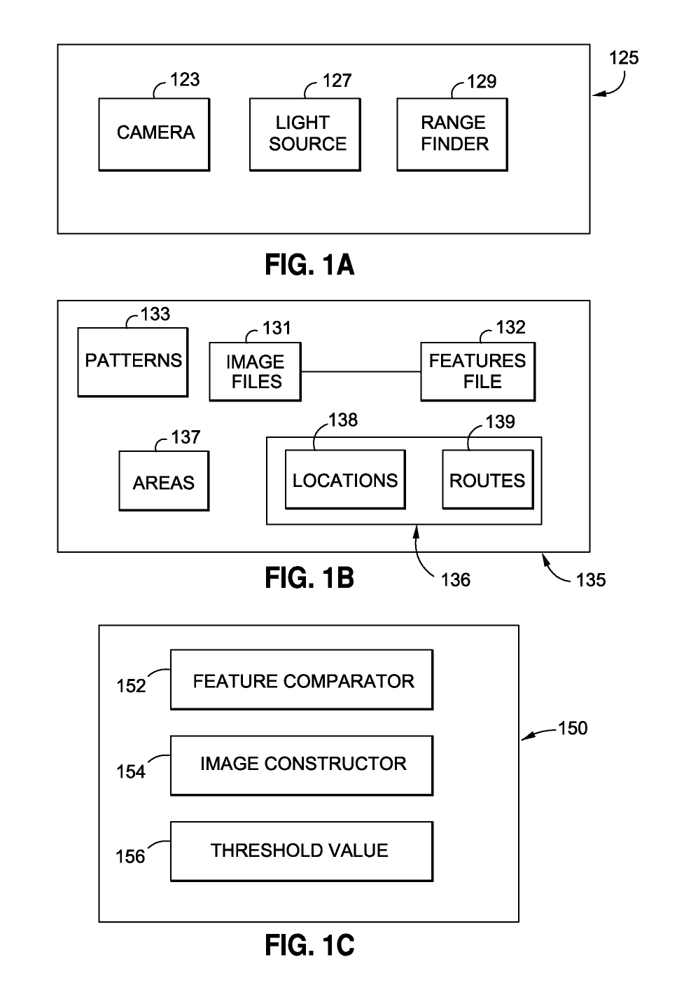

Referring concurrently now to FIGS. 1, 1B and 2, an exemplary mobile robot 110 is illustrated as traveling through an exemplary navigable area 199. In the exemplary embodiment of FIG. 2, the mobile robot 110 includes a housing 115. One or more of the detector modules 125 are coupled to the housing 115 on housing sides 120a and 120b. While illustrated in a perspective view showing only housing sides 120a and 120b, it will be understood that certain embodiments of the mobile robot 110 also include other detector modules 125 on sides of the housing 115 not visible according to the view of FIG. 2, and in particular, that a detector module 125 may be coupled to a housing side facing the vertical surface 190 and configured to detect an ink mark disposed on the vertical surface 190.

The landmarks 171 in exemplary embodiments, comprise an arbitrarily-shaped ink mark 175. The arbitrarily-shaped ink mark 175 comprises an invisible ink that is human imperceptible. For example, the arbitrarily-shaped ink mark 175 may comprise an ultraviolet ink visible only under ultraviolet illumination. The arbitrarily-shaped ink mark 175 is advantageously disposed on a vertical surface 190 within the area 199. In the subject disclosure that follows, landmarks 171 are represented for illustrative purposes by differently shaped ink marks 175. However, it will be understood that the landmarks 171 may be of the same arbitrary shape or of differing arbitrary shapes. For illustrative purposes, only one landmark 171 at a location is depicted in FIG. 2, however, it will be understood that one or more landmarks 171 can be employed in a pattern at a single location to assist in autonomous navigation of the mobile robot 110 through the area 199. Further, such landmarks 171 can be provided at different locations along the intended route of the mobile robot 110.

In operation, the mobile robot 110 travels along a horizontal surface 198 within a navigable area 199. During this travel, the detector module 125 will scan the vertical surface 190 in the vicinity of the mobile robot 110 and detects the presence of landmarks 171 within the area 199. Detection of one or more ink marks 175 will normally represent a landmark 171 used for navigation of the mobile robot 110. The detection of an ink mark 175 is performed by the detector module 125. Data representing the detection of an ink mark 175 is transmitted by the detector module 125 to the processor 130. The processor 130 compares the detected ink mark 175 to one or more image files 131 stored in the memory module 135. The processor 130 determines whether the detected ink mark 175 matches one of the stored image files 131 associated with one of the landmarks 171. The processor 130 is configured to evaluate and determine the current location of the mobile robot 110 in the area 199 according to a location file 138 associated with the particular detected ink mark 175 that has been matched.

In certain exemplary embodiments, the detected ink mark 175 is compared to the stored image files 131 using a confidence matching process performed by the confidence matching module 150. The processor 130 receives data from the detector module 125 and processes the data for transmission to the drive module 161 according to the confidence matching module 150. The confidence matching module 150 evaluates a detected ink mark 175 for features present in the detected ink mark 175. The presence of features in the detected ink mark 175 is assessed in comparison to stored features 132 present in a stored image file 131. In certain exemplary embodiments, a detected ink mark 175 may be determined to be a landmark 171 based on a percentage of features present that match features present in a stored image file 131. Further details of an exemplary confidence matching process follows below.

With continued reference to FIGS. 1 and 2, the processor 130 transmits data including the detection of the landmark 171 and data associated with the detected landmark 171 upon verification that a detected ink mark 175 is qualified as a landmark 171. Data associated with the landmark 171 may include a location 182 associated with the landmark 171 and a determination verifying that the mobile robot 110 is traveling along an intended route according to a stored file of routes 139 (see FIG. 1B). The navigation system 140 is configured to drive the mobile robot 110 through the area 199 according to a determined location (e.g., location 182 of FIG. 2). For example, if the processor 130 determines that the mobile robot 110 is at the location 182, the navigation system 140 sends a command signal to the drive module 161 to direct the mobile robot 110 toward the next location. The navigation system 140 directs the mobile robot 110 to proceed along its current direction of travel 192 or may steer the mobile robot 110 to change course if necessary and proceed toward the next landmark 171. It will be understood that changing course may include pivoting the mobile robot 110 to move at a different pitch along the horizontal surface 198 or, in some cases may include a retrograde along the current direction of travel. The course of travel of the mobile robot 110 may be based on the data associated with an individual ink mark 175 or may be based on a pattern of ink marks.

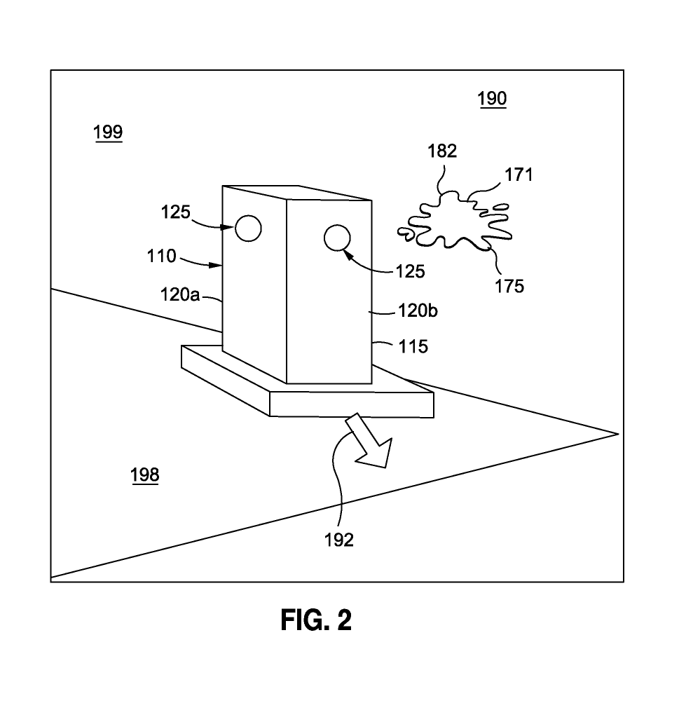

For example, referring now to FIG. 3, a pattern 170 of arbitrarily-shaped ink marks (172, 173, 174, 175) is illustrated. The arbitrarily-shaped ink marks (172, 173, 174, 175) comprise a plurality of ink splatters formed in respectively unique shapes. The pattern 170 is disposed on one or more vertical surfaces 190. The arbitrarily-shaped ink marks (172, 173, 174, 175) may be disposed on the vertical surface 190 with respective ink marks comprising individual shapes for identifying respective landmarks 171. The arbitrarily-shaped ink marks (172, 173, 174, 175) are disposed at spaced intervals 176, 177, 178 from one another. In certain exemplary embodiments of pattern 170, the arbitrarily-shaped ink marks (172, 173, 174, 175) are spaced at random intervals 176, 177, 178 from each other. For sake of illustration, the arbitrarily-shaped ink marks (172, 173, 174, 175) are illustrated as a pattern according to such randomly spaced intervals 176, 177, 178 of locations 182, 183, 184, and 185. However, it will be understood that according to other embodiments, the spacing between locations 182, 183, 184, and 185 is at uniform intervals as well. In certain aspects, the arbitrarily-shaped ink marks (172, 173, 174, 175) are non-uniformly shaped or are symmetrically shaped. For example, arbitrarily-shaped ink marks (173, 174, 175) may be considered non-uniformly shaped. In another example, arbitrarily-shaped ink mark 172 may be considered symmetrically shaped.

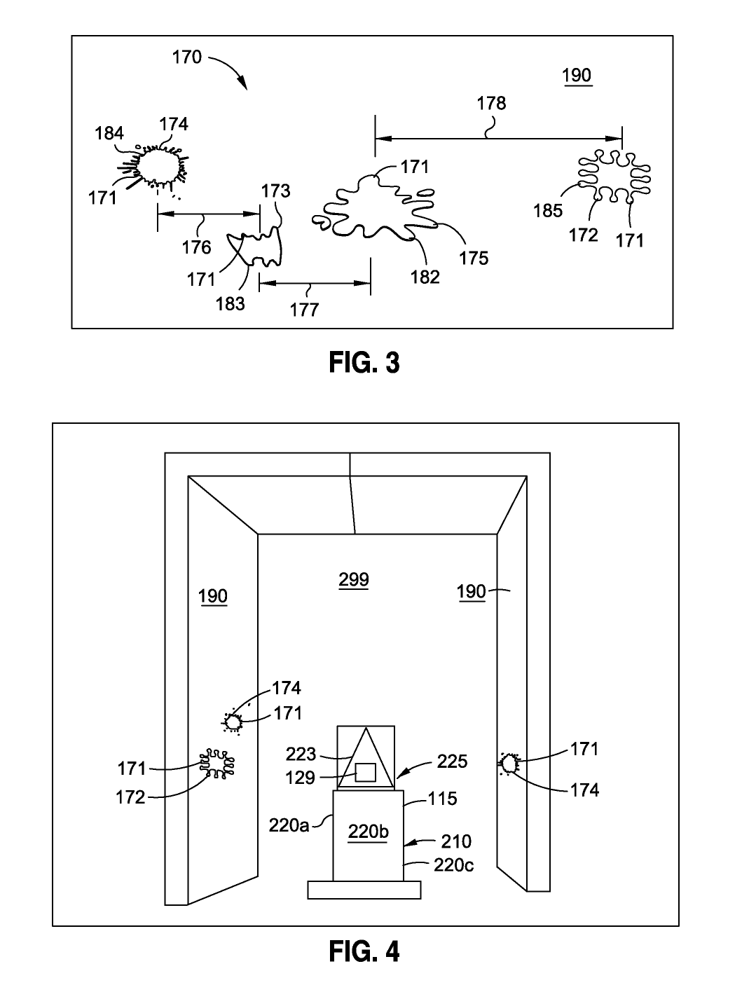

Referring now to FIGS. 1 and 4 concurrently, an exemplary embodiment of a mobile robot 210 is illustrated. The mobile robot 210 is similarly configured to the mobile robot 110 of FIG. 2 except that a detector module 225 is also disposed atop the housing 115 of the mobile robot 210. The housing 115 includes housing sides 220a, 220b, 220c, and a housing side 220d which may be understood as being disposed opposite of housing side 220b. The area 299 navigated by the mobile robot 210 includes vertical surfaces 190 on more than one housing side (220a, 220b, 220c, and 220d) of the mobile robot 210. One or more of the vertical surfaces 190 includes respective arbitrarily-shaped ink marks. For example, arbitrarily-shaped ink marks 172 and 174 are disposed on a first vertical surface 190 facing a side 220a of the mobile robot 210 while an arbitrarily-shaped ink mark 174 is disposed on a second vertical surface 190 facing a side 220c of the mobile robot 210. The detector module 225 includes an omni-directional camera 223 configured to detect ink marks in a 360° field of view. The mobile robot 210 also includes a range finder 129 configured to determine the distance between the mobile robot 210 and a detected ink mark (172, 174).

In operation, the mobile robot 210 detects an ink mark (172, 174) to any one of its sides 220a, 220b, 220c, and 220d and upon verification of the ink mark (172, 174) as a landmark 171, the processor 130 extracts information about the current location of the mobile robot 110 from the memory module 135. In certain aspects, simultaneous detection of ink marks (172, 174) are performed. The location and current direction of travel of the mobile robot 210 is adjusted iteratively as the mobile robot 210 distances itself from one landmark 171, (for example, ink mark 174 detectable from housing sides 220a and 220d) and approaches another landmark 171 (for example, either ink mark 174 detectable from housing side 220c or ink mark 172). Thus, information such as the predetermined location of a landmark 171, the current location of the mobile robot 210 in the area 299, the distance of the mobile robot 210 from a next landmark 171, and a projected course of travel to a next landmark 171 may be determined from the detection of one or more ink marks 172, 174.

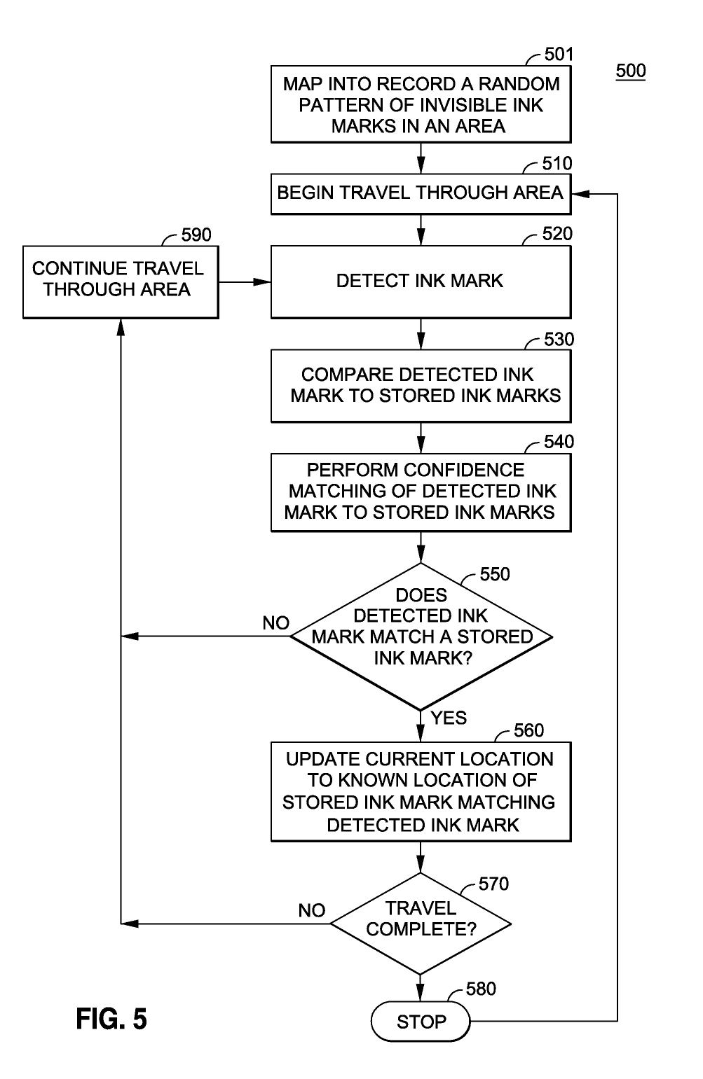

Referring to FIG. 5 concurrently with FIG. 1, a method 500 of autonomous navigation according to an exemplary embodiment of the present disclosure is described. In operation 501, a random pattern of invisible ink marks is mapped for a navigable area 199 of travel. A mobile robot 110 begins travel through a navigable area 199 in operation 510. In operation 520, the mobile robot 110 detects with a detector module 125, an arbitrarily-shaped ink mark on a surface in the navigable area 199. The mobile robot 110 compares the detected ink mark 175 to stored image files in operation 530. In operation 540, a confidence matching process is performed matching the detected ink mark 175 to one or more of the stored image files. In operation 550, a determination is made determining if the detected ink mark 175 matches one or more of the stored image files. The current location of the mobile robot 110 is updated based on a location associated with a landmark file when the detected ink mark 175 matches a stored image file in operation 560 signifying the verification of the ink mark as a detected landmark. Otherwise, if the detected ink mark 175 does not match a stored image file, the method proceeds to operation 590 where the mobile robot 110 continues to travel through the navigable area 199. In operation 570, a decision is made to determine if travel through the navigable area 199 is complete. If travel through the navigable area 199 is complete, then the mobile robot 110 stops travel through that navigable area 199 and the mobile robot 110 begins the operations of method 500 again through the same or another area. If travel is not complete, then the mobile robot 110 proceeds to operation 590 and continues travel through the navigable area 199.

Referring to FIGS. 1 and 6, an example of an area employing autonomous navigation of the mobile robot 110 is illustrated. The area 199 may include arbitrarily-shaped ink marks 175 and 172 disposed on a vertical surface 190. The arbitrarily-shaped ink mark 175 may be positioned at a location 182 and the arbitrarily-shaped ink mark 172 may be positioned at a location 185. The arbitrarily-shaped ink mark 175 may be partially obstructed by an object 196. The arbitrarily-shaped ink mark 172 may have incurred damage, for example, via scraping or damage to the vertical surface 190 resulting in a damaged portion 195. In either instance, the mobile robot 110 may nonetheless detect the presence of the arbitrarily-shaped ink marks 172 and 175 via the detector module 125 illustrated in this example, as disposed on a side of the mobile robot 110 facing the vertical surface 190. The mobile robot 110 processes the respective detection of ink marks 172 and 175 for identification of a known landmark, despite that portions of the ink marks 172 and 175 are obscured or missing. In certain exemplary embodiments, the mobile robot 110 employs a confidence matching process by using the confidence matching module 150 to evaluate a partially obstructed ink mark 175 or damaged ink mark 172 for matching to a stored image file 131. In one exemplary embodiment, confidence matching may include extracting features from the ink marks 172 and 175 and comparing those extracted features to features file 132 associated with image files 131.

Referring now to FIG. 6A, an example of an arbitrarily-shaped ink mark 175 is illustrated in accordance with a shape feature identification that may be employed for use in a confidence matching process. An arbitrarily-shaped ink mark 175 may be scanned to identify shape features present in the shape of the ink mark 175. For example, the arbitrarily-shaped ink mark 175 may be scanned to identify features such as, a straight edge 605, a cliff edge 610, a convex edge 615, and an island 620. Other features identified may include a recess 625, and a solid area 630. Additional features may include, for example, a finger 645, a rounded tip 640 and a pointed tip 650. It will be understood that other features may be included in the confidence matching process and the aforementioned features are described as exemplary features for sake of illustration.

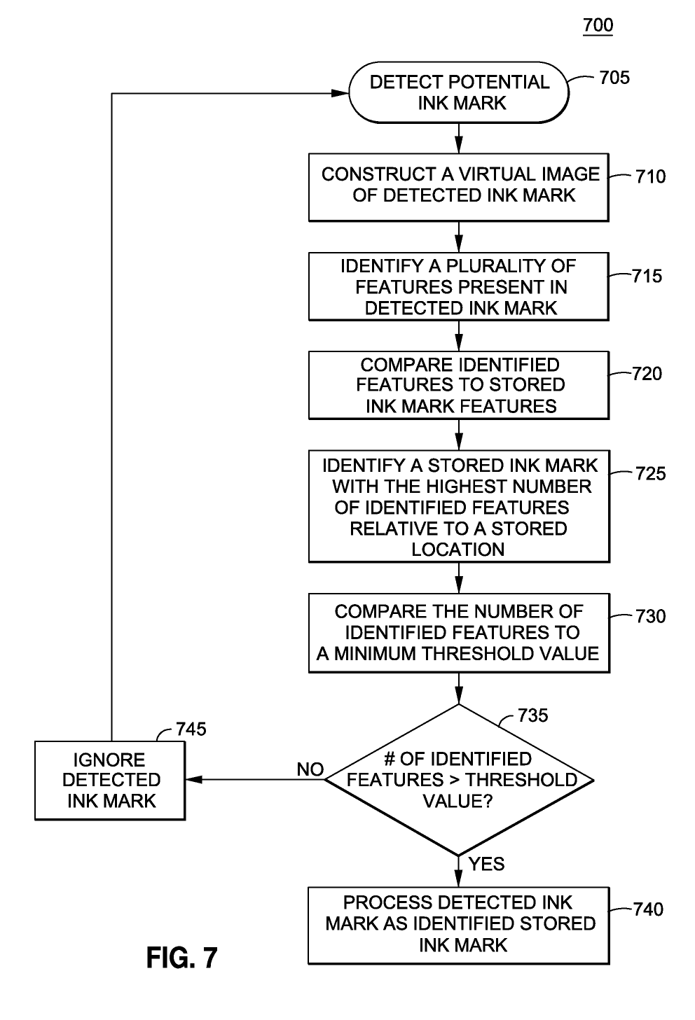

Referring now to FIGS. 1, 1B, 1C, and 7, an example of a confidence matching process 700 is illustrated in accordance with embodiments of the present disclosure. In operation 705, a potential ink mark is detected by the detector module 125. A virtual image of the detected ink mark is constructed by the image constructor 154 in operation 710. The virtual image is scanned to identify features present in the detected ink mark 175 in operation 715. The identified features are compared to stored image files 131 in operation 720 that may include one or more of the identified features in stored feature files 132. In operation 725, a stored image 131 including the highest number of identified features is identified. It will be understood that the identified stored image 131 may include the identified features in an orientation consistent with the detected ink mark 175. In operation 730, the number of features identified are compared to a threshold value 156 stored in the confidence matching module 150. In the event the number of identified features is less than the threshold value 156, the process will, according to operation 745, ignore the detected ink mark and proceed back to operation 705. In the event the number of identified features is at least as high as the threshold value 156, operation 740 processes the detected ink mark 175 as an identified landmark 171.

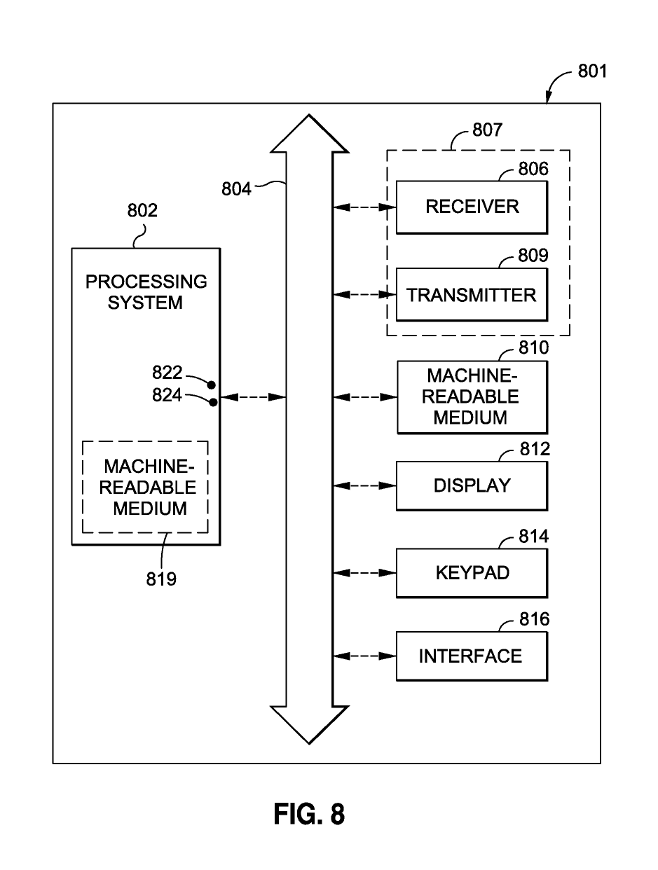

FIG. 8 is a block diagram illustrating an example of a processing system for use in the present disclosed embodiments. A processing system 801 may be a remote server (not shown) or remote command station (not shown). The system 801 may include a processing system 802, which may be processor 130. The processing system 802 is capable of communication to the remote server with a receiver 806 and a transmitter 809 through a bus 804 or other structures or devices. It should be understood that communication means other than busses can be utilized with the disclosed configurations. The processing system 802 can generate audio, video, multimedia, and/or other types of data to be provided to the transmitter 809 for communication. In addition, audio, video, multimedia, and/or other types of data can be received at the receiver 806, and processed by the processing system 802.

The processing system 802 may include a general-purpose processor or a specific-purpose processor for executing instructions and may further include a machine-readable medium 819, such as a volatile or non-volatile memory, for storing data and/or instructions for software programs. The instructions, which may be stored in a machine-readable medium 810 and/or 819, may be executed by the processing system 802 to control and manage access to various networks, as well as provide other communication and processing functions. The instructions may also include instructions executed by the processing system 802 for various user interface devices, such as a display 812 and a keypad 814. The processing system 802 may include an input port 822 and an output port 824. Each of the input port 822 and the output port 824 may include one or more ports. The input port 822 and the output port 824 may be the same port (e.g., a bi-directional port) or may be different ports.

The processing system 802 may be implemented using software, hardware, or a combination of both. By way of example, the processing system 802 may be implemented with one or more processors 130. A processor 130 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable device that can perform calculations or other manipulations of information.

A machine-readable medium can be one or more machine-readable media. Software shall be construed broadly to mean instructions, data, or any combination thereof, whether referred to as software, firmware, middleware, microcode, hardware description language, or otherwise. Instructions may include code (e.g., in source code format, binary code format, executable code format, or any other suitable format of code).

Machine-readable media (e.g., 819) may include storage integrated into a processing system, such as might be the case with an ASIC. Machine-readable media (e.g., 810) may also include storage external to a processing system, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device. In addition, machine-readable media may include a transmission line or a carrier wave that encodes a data signal. Those skilled in the art will recognize how best to implement the described functionality for the processing system 802. According to one aspect of the disclosure, a machine-readable medium is a computer-readable medium encoded or stored with instructions and is a computing element, which defines structural and functional interrelationships between the instructions and the rest of the system, which permit the instructions' functionality to be realized. In one aspect, a machine-readable medium is a machine-readable storage medium or a computer-readable storage medium. Instructions can be, for example, a computer program including code.

An interface 816 may be any type of interface and may reside between any of the components shown in FIG. 8. An interface 816 may also be, for example, an interface to the outside world (e.g., an Internet network interface). A transceiver block 807 may represent one or more transceivers, and each transceiver may include a receiver 806 and a transmitter 809 for communicating manual operations of the mobile robot 110. A functionality implemented in a processing system 802 may be implemented in a portion of a receiver 806, a portion of a transmitter 809, a portion of a machine-readable medium 810, a portion of a display 812, a portion of a keypad 814, or a portion of an interface 816, and vice versa

Those of skill in the art would appreciate that the various illustrative blocks, modules, elements, components, methods, and algorithms described herein may be implemented as electronic hardware, computer software, or combinations of both. For example, methods 500 and 700 may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology. For example, the specific orders of blocks in FIG. 1 may be rearranged, and some or all of the blocks in FIG. 1 may be partitioned in a different way.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various operations in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

Terms such as “top,” “bottom,” “front,” “rear”, “side” and the like as used in this disclosure should be understood as referring to an arbitrary frame of reference, rather than to the ordinary gravitational frame of reference. Thus, a side surface, a top surface, a bottom surface, a front surface, and a rear surface may extend upwardly, downwardly, diagonally, or horizontally in a gravitational frame of reference.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A mobile robot, comprising:
a housing;
a memory module coupled to the housing, configured to store an image file of at least one ink mark that is arbitrarily-shaped and is human-imperceptible and that forms a landmark on a navigable route;
a detector mounted to the housing, configured to detect human-imperceptible ink marks marked on a surface;
a confidence matching system coupled to the memory module and the detector, the confidence matching system configured to determine whether a detected ink mark is a landmark based on a comparison of the detected ink mark with the stored image file of the at least one ink mark; and
a navigation system coupled to the confidence matching system configured to navigate the robot through an area along the navigable route based on recognition of the landmark.

2. The robot of claim 1 further comprising a light source coupled to the housing and configured to illuminate the ink mark.

3. The robot of claim 1 wherein the detected ink mark is visible under ultra-violet illumination.

4. The robot of claim 1 wherein the detector is disposed to detect ink marks on a vertical surface.

5. The robot of claim 1 wherein the memory module includes a map of the area including the landmark.

6. The robot of claim 5 wherein the memory module includes a stored location of the landmark on the map.

7. The robot of claim 1 wherein the detector is disposed to detect ink marks in a 360 degree field of view.

8. A method of navigating a robot, including:
recording a random pattern of invisible marks in an area as a map file in the robot;
detecting the invisible marks using a camera mounted to the robot and wherein the camera is configured for detecting light in the non-visible spectrum; and
navigating the robot through the area based on the robot recognizing the detected invisible marks.

9. The method of claim 8 wherein the invisible marks are an unevenly spaced plurality of ink splatters.

10. The method of claim 9 wherein the plurality of ink splatters comprise respectively unique shapes for identifying different locations in the area.

11. The method of claim 10 further comprising matching respective detected invisible marks to stored unique shapes associated with a plurality of locations stored in the map file.

12. The method of claim 8 wherein the invisible marks are disposed on a plurality of surfaces in the area.

13. The method of claim 8 wherein the invisible marks are formed by ultra-violet ink.

14. The method of claim 8 further comprising scanning the area on more than one side of the robot for the invisible marks.

15. The method of claim 8 further comprising matching the detected invisible marks to one or more locations stored in the map file.

16. A system of autonomous robot navigation, comprising:
a mobile robot;
a detector coupled to the mobile robot, the detector configured to detect non-uniform invisible ink marks disposed on vertical surfaces; and
a processor coupled to the mobile robot, the processor configured to match the detected non-uniform invisible ink marks to pre-stored image files of landmarks based on a minimum number of shape features detected in the detected non-uniform invisible ink marks, the processor further configured to determine whether detected non-uniform invisible ink marks match a stored map file of predetermined locations of the landmarks.

17. The system of autonomous robot navigation of claim 16 further comprising a range finder configured to determine a distance between the mobile robot and a detected one or more of the non-uniform invisible ink marks.

18. The system of autonomous robot navigation of claim 16 further comprising a light source coupled to the mobile robot, the light source configured to emit light in the non-visible spectrum and illuminate the non-uniform invisible ink marks.

19. The system of autonomous robot navigation of claim 16 further comprising a confidence matching module configured to determine whether detected non-uniform invisible ink marks match one of a plurality of stored non-uniform invisible ink mark profiles.

20. The system of autonomous robot navigation of claim 16 further comprising a navigation system configured to navigate the robot based on location information associated with respective non-uniform invisible ink marks.

21. A mobile robot navigation system, comprising:
a memory module including stored image files of landmarks and stored maps of navigable areas including landmarks;
a confidence matching module, coupled to the memory module, including an image constructor configured to reconstruct virtual images from data representing detected arbitrarily-shaped and human-imperceptible ink marks; and
a processor coupled to the memory module and the confidence matching module, configured to compare the reconstructed virtual images to one or more of the stored image files, the processor further configured to determine whether one of the detected arbitrarily-shaped and human-imperceptible ink marks is one of the landmarks based on the comparison, the processor further configured to generate a command signal to navigate a mobile robot through one of the navigable areas based on a location of the detected landmark in one of the stored maps.

22. The mobile robot navigation system of claim 21 wherein:
the confidence matching module includes a feature comparator configured to extract features from the reconstructed virtual images; and
the processor is configured to compare extracted features from the reconstructed virtual images to features present in a stored features file associated with one or more of the stored image files.

23. The mobile robot navigation system of claim 22 wherein the processor is configured to determine whether the detected arbitrarily-shaped and human-imperceptible ink mark is one of the landmarks based on a threshold value of features present in the detected arbitrarily-shaped and human-imperceptible ink mark.

24. The mobile robot navigation system of claim 21 wherein the processor is configured to navigate the mobile robot according to a stored route file.

25. The mobile robot navigation system of claim 21 wherein the processor is configured to update a current location of the mobile robot based on the detected landmark.
